(19) United States
(12) Patent Application Publication
(10) Pub. No.: US 2009/0157489 A1
(43) Pub. Date: Jun. 18, 2009

(54) System and method for performance evaluation

(75) Inventor: Peter Leman, South Windsor, CT (US)

Correspondence Address: ROPES & GRAY LLP, PATENT DOCKETING 39/41, ONE INTERNATIONAL PLACE, BOSTON, MA, 02110-2624, US

(73) Assignee: Hartford Fire Insurance Company, Hartford, CT (US)

(21) Appl. No.: 12/002,240

(22) Filed: Dec. 13, 2007

(51) Int. Cl. G06Q 10/00

(52) U.S. Cl. 705/11

(57) ABSTRACT

A system for determining a compensation rate is disclosed that includes a database for storing insurance policy data attributed with the seller of insurance and a processor. The processor is configured to retrieve, from the database, insurance policy data for a first period of time, wherein the first period of time is substantially less than one year in length. The processor is also configured to, based on the retrieved insurance policy data, derive a partial year compensation rate for the seller of insurance to apply to a second period of time. The second period of time is substantially less than one year in length and the first period of time ends prior to beginning of the second period of time. The processor also derives a partial year compensation rate to apply to revenue attributed to the seller of insurance during the second period.

### FIELD OF THE INVENTION

In general, the invention relates to a computerized system and method for calculating a level of performance. More specifically, the invention relates to a computerized system and method for determining a compensation rate and a compensation amount based on calculated performance.

### BACKGROUND OF THE INVENTION

Many insurance companies utilize independent or loosely affiliated insurance agents to sell their insurance products. These agents will typically sell insurance products for multiple carriers. Current trends in the insurance industry focus on agent compensation plans that include commission rates that are determined prospectively, i.e., prior to the sale of a policy. Thus, if asked, an agent can definitively inform a customer of the commission the agent will earn for a sale.

To date, these prospective compensation plans have been based on annual agent performance. Basing compensation rates on annual performance, however, has a number of shortcomings. In particular, in such plans, poor performance is self-perpetuating. That is, if an agent does not perform well in a first year for a carrier, the agent's compensation rate for the following year for that carrier will be relatively low. This poses a particular problem for new agents who may take several years to perform well enough to earn a competitive compensation rate. In addition, such plans fail to take into account swings that may occur through the year. As a result, if an agent has poor performance, e.g., during the first half of a year, there is little the agent can do in the second half of the year to improve its subsequent year compensation rate. Thus, a need exists in the art for a compensation plan and systems and methods for implementing such a plan that take into account the variability of insurance sales swings that may occur during a year.

### SUMMARY OF THE INVENTION

A number of the disadvantages of annual prospective compensation plans can be mitigated by including multiple distinct compensation periods within a given year. By determining compensation rates and making supplemental compensation payments (e.g., supplemental commissions) on a semi-annual or quarterly basis, agents who would otherwise have reduced compensation for an entire year can improve their performance and thereby see their compensation rates improve more rapidly. In addition, by having shorter compensation periods, insurance carriers can adjust their compensation plans more rapidly to adapt to changes in market conditions.

Therefore, according to one aspect, the invention relates to a system for determining compensation for a seller of insurance. The seller of insurance may be an insurance agency or an employee of an insurance agency. The system may determine compensation rates for an agency collectively and/or for employees of the insurance agency.

The system includes a database for storing insurance policy data attributed with the seller of insurance and a processor. The processor is configured to retrieve, from the database, insurance policy data for a first period of time, wherein the first period of time is substantially less than one year in length. For example, the first period may be about three or about six months in length. The processor is also configured to, based on the retrieved insurance policy data, derive a partial year compensation rate for the seller of insurance to apply to a second period of time. The second period of time is substantially less than one year in length and the first period of time ends prior to beginning of the second period of time. The processor also derives a partial year compensation rate to apply to revenue attributed to the seller of insurance during the second period. In one embodiment, the partial year compensation rate takes the place of an annual compensation rate.

In one embodiment, the partial year compensation rate is used to determine a compensation amount for the seller of insurance. The processor is then configured to output the determined compensation amount.

According to various embodiments, different factors or combinations of factors are used to determine the partial year compensation rate. The factors and rates may vary from period to period based upon prevailing market conditions and other factors related to the objectives of the insurance company. The selected factors may be included within an agreement (e.g., on paper or in an electronic communication) documenting the plan that is provided to or made available to the seller of insurance. Illustrative factors include, without limitation, the profitability of the policies sold by the seller of insurance, the volume of insurance policies sold by the seller of insurance (including new and/or renewal policies), a policy retention factor, a performance improvement factor, revenue attributed to the seller of insurance, and the level and/or quality of information provided by the seller of insurance to the insurance carrier.

In one embodiment, the processor is configured to retrieve data from the database reflecting performance of the seller of insurance during substantially the entirety of an immediately preceding calendar year and calculate an annual prospective compensation rate based on that data. The processor, using that information, determines an aggregate partial year compensation rate based on the annual prospective compensation rate and the partial year compensation rate.

In another embodiment, the processor is configured to schedule payments to the seller of insurance based on the derived partial year compensation rate. The processor, in one embodiment, is configured to allocate funds to an account associated with the seller of insurance prior to a scheduled payment. The amount allocated is based on the determined compensation amount. This early allocation enables the seller of insurance to obtain an interim payment on the earned compensation amount.

According to another aspect, the invention relates to a method for determining compensation for a seller of insurance. The method includes storing insurance policy data attributed with the seller of insurance in a database. A processor then retrieves, from the database, insurance policy data for a first period of time, wherein the first period of time is substantially less than one year in length. For example, the first period may be about three or about six months in length. The processor, based on the retrieved insurance policy data, then derives a partial year compensation rate for the seller of insurance to apply to a second period of time. The second period of time is substantially less than one year in length and the first period of time ends prior to beginning of the second period of time. The processor also derives a partial year compensation rate to apply to revenue attributed to the seller of insurance during the second period.

In one embodiment, the partial year compensation rate is used to determine a compensation amount for the seller of insurance. The method concludes with the processor outputting the determined compensation amount.

According to still another aspect, the invention relates to computer readable medium encoding computer executable instructions for causing a processor to carry out the method referred to above.

According to still another aspect, the invention relates to a method for obtaining compensation for the sale of insurance. The method includes transmitting, by a computer associated with a seller of insurance, insurance sales data for a period of time that is substantially less than a year. The seller of insurance, during a future period that is also substantially less than one year in length, receives compensation based on a compensation rate determined by the insurance carrier based on the received data.

### BRIEF DESCRIPTION OF THE DRAWINGS

The foregoing discussion will be understood more readily from the detailed description of the invention with reference to the following drawings:

FIG. 1 is a block diagram of a system for calculating agent compensation, according to an illustrative embodiment of the invention.

FIG. 2 is a block diagram of a computer architecture suitable for implementing various servers incorporated into the system of FIG. 1, according to an illustrative embodiment of the invention.

FIG. 3 is a timeline illustrating a method of determining an annual prospective compensation rate, according to an illustrative embodiment of the invention.

FIGS. 4A and 4B are timelines illustrating methods of determining partial year compensation rates according to illustrative embodiments of the invention.

FIG. 5 depicts several aggregate compensation rates that may be calculated according to illustrative embodiments of the invention.

FIG. 6 is a flow chart of a method of calculating a compensation amount, according to an illustrative embodiment of the invention.

### DESCRIPTION OF CERTAIN ILLUSTRATIVE EMBODIMENTS

To provide an overall understanding of the invention, certain illustrative embodiments will now be described, including a system and methods for calculating agent compensation. However, it will be understood by one of ordinary skill in the art that the methods and systems described herein may be adapted and modified as is appropriate for the application being addressed and that the systems and methods described herein may be employed in other suitable applications, and that such other additions and modifications will not depart from the scope hereof.

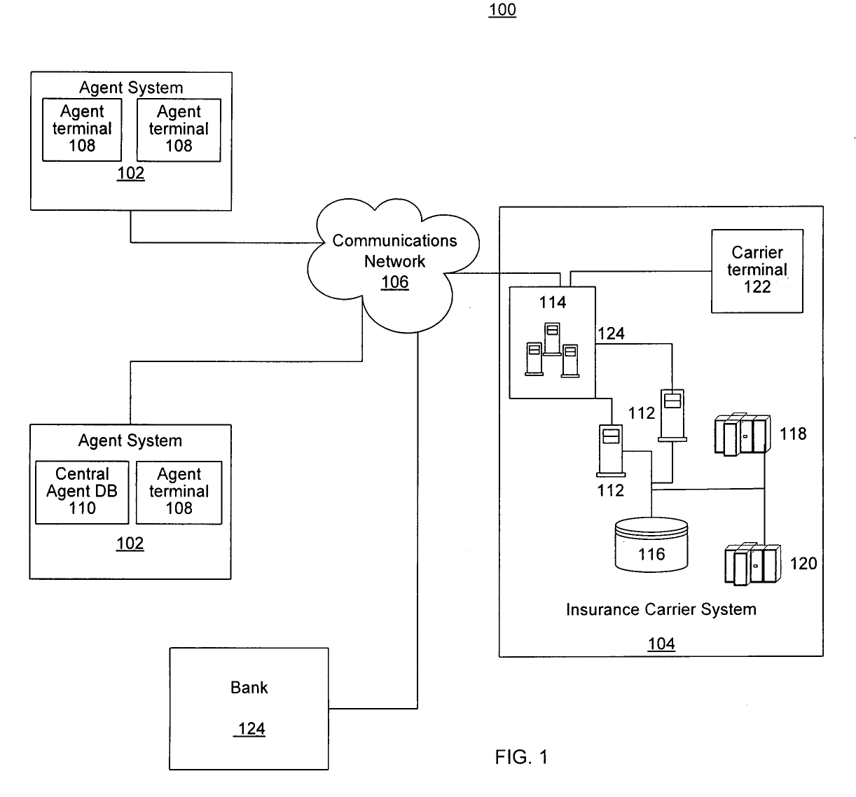

FIG. 1 is a block diagram of a system 100 for calculating agent compensation, according to an illustrative embodiment of the invention. The term “insurance agent”, as used herein, shall refer to an individual licensed insurance agent or an insurance agency made up of principals and employees, each of whom is licensed and may participate in the selling of insurance products. An “insurance agent” may also include an employee of an insurance carrier. In one implementation, the system 100 calculates a single compensation rate that applies to activity within an entire insurance agency, and which is paid to the principals of the insurance agency. In other implementations, the system 100 calculates a first compensation rate that applies to the insurance agency as a whole, and which is paid to the principals, and additional compensation rates, which apply and are paid to individual agents.

System 100 includes multiple insurance agent systems 102 in communication with an insurance carrier system 104 over a communication network 106. Each insurance agent system 102 includes one or more agent terminals 108 via which employees of the insurance agent may interact with the insurance carrier system 104. Agent terminals 108 preferably include software via which an agent may submit applications for, obtain quotes for, issue, and/or renew insurance policies for customers of the insurance agent. The software may also be configured for reporting claims to the insurance carrier system 104. In one implementation, such software includes a web browser configured for receiving web page data from the insurance carrier system 104. In alternative implementations, the software includes a thin or thick client that communicates both with the insurance carrier system 104 as well as a central agent database 110. The central agent database preferably stores data related to agent customers, issued policies, and products available from one or more carriers. The central agent database 110 may execute on one of the agent terminals 108 or on its own computing device. In still another implementation, the software on the agent terminals 108 includes software for interacting directly with the central agent database 110, which, in turn, includes software to communicate with the insurance carrier system 104, for example, via a web service. In general, the agent terminals 1018 can be any computing device known in the art, including for example, a personal computer, a lap top computer, or a personal digital assistant.

In one implementation, at least a portion of the functionality of one or more agent terminals 108, is carried out by a computing device operated by the insurance carrier. In this implementation, the insurance carrier offers a web site for direct customer interaction, for example to request renewal of a pending policy.

The insurance carrier system 104 includes a plurality of application servers 112, a plurality of load balancing proxy servers 114, a database 116, a compensation rate processor 118, a payment processor 120 and one or more carrier terminals 122. These computing devices are connected by a local area network 124.

The application servers 112 are responsible for interacting with the agent terminals 108. For example, the application servers 112 include software for generating web pages for communication to the agent terminals 108. These web pages serve as user interfaces for the insurance agent to interact with the insurance carrier system 104. Alternatively, or in addition, one or more of the application servers 112 may be configured to communicate with thin or thick clients operating on the agent terminals 108. The load balancing proxy servers 114 operate to distribute the load among application servers 112.

The database 116 stores information about insurance products sold by the insurance agents. For each policy sold and/or renewed by an insurance agent, the database 116 includes for example and without limitation, the following data fields: the employee responsible for the sale or renewal, the date of purchase, dates of subsequent renewals, the premium, insurance claims history, policy endorsements, applicable automation services (for example, electronic billing, automatic electronic funds transfers, centralized customer service plan selections, etc.), customer information, customer payment history, loss experience, or derivations thereof.

In addition to storing data in relation to insurance policies, the database 116 may also store data separately in relation to each insurance agent. The data may be stored both in aggregate form and broken down by time period. For example, data may be stored by week, month, quarter, six-month period, year, calendar year, and/or the lifetime of the agent's relationship with the insurance carrier. For example, the database 116 may store policy volume data, including the number of new policies sold, the number of policies renewed, and/or the total number of policies in force. In addition, or in the alternative, similar volume data may be stored based on a number of coverages instead of a number of policies. In addition, the database 116 may store profitability data associated with the policies placed by agents and/or agent employees. Profitability data includes the net of premiums received and claims payments associated with the agent and/or employee. In addition or in the alternative, the profitability data includes a percentage of the policies or coverages sold by the agent or employee that are profitable. The database 116 may also store a policy retention factor for each agent and/or employee determined based on the percentage of policies sold by the agent and/or employee that renew. Additional data stored by the database 116 may include data indicating an agent's or employee's success with selling additional services and implementing available automation tools, including electronic billing, automatic electronic funds transfers, centralized customer service plan selections, and automatic collection of premiums from agents. Furthermore, for each of the above data types for each time period for which data is stored, the database 116, in one implementation, stores improvement factors indicating a level of improvement over an immediately preceding time period or an equivalent time period from a prior calendar year. To the extent any of this data is not stored by the database 116 separately from overall policy data, preferably the database stores sufficient data in relation to each policy such that the above-described data could be derived from the policy data.

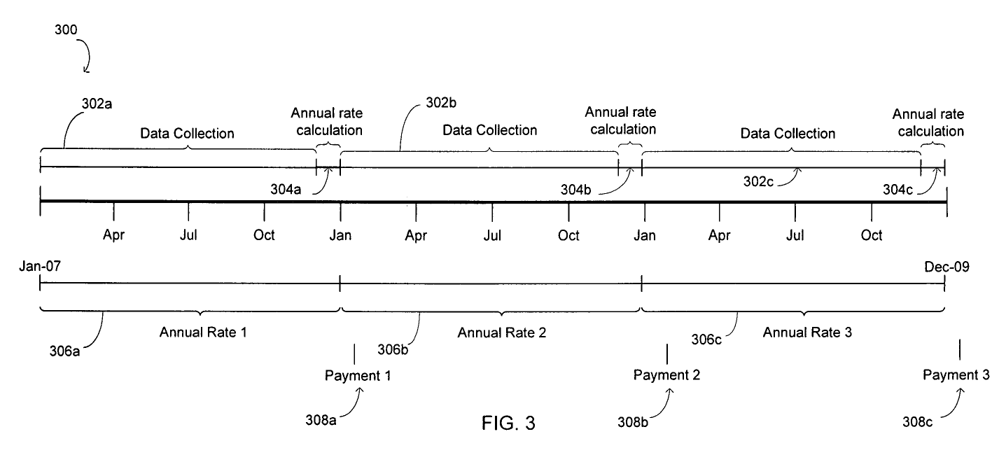

The compensation rate processor 118 is configured to, based on the data stored in the database 116, determine a compensation rate for insurance agents and/or licensed employees of insurance agents selling the carrier's products. In general, and as described further in relation to FIGS. 3-5, the compensation rate processor 118 determines the compensation rate based on a combination of two or more of a base compensation rate, an annual prospective compensation rate, and a partial year prospective compensation rate.

The base compensation rate is a common commission rate paid on sales of new policies and/or renewals. While the base compensation rate may vary based on coverage, line of business, or whether a policy is a new policy or a renewal, the base compensation rate does not vary based on prior agent or employee performance. The base compensation rate, in one implementation, is a fixed percentage of a policy's expected premium.

As described further in relation to FIG. 3, the annual prospective compensation rate includes a percentage of premiums that is determined based on the agent's or employee's performance during the previous calendar year or other predetermined (i.e., not rolling) year-long period (e.g., the insurance carrier's fiscal year or year long periods beginning on the date the agent's relationship with the carrier commenced and subsequent anniversaries thereof). Suitable annual prospective compensation rates fall range from about 1% to about 10%, though rates falling outside this range may also be employed without departing from the scope of the invention.

The partial year prospective compensation rate is a rate determined on the performance of an agent during a predetermined prior period, which is substantially less than one year long, for example, two months, three months, four months, or six months. Suitable partial year compensation rates fall range from about 1% to about 10%, though rates falling outside this range may also be employed without departing from the scope of the invention. The compensation rate processor 118 outputs the derived compensation rate and/or its components to the database 116 and/or to the payment processor 120.

The payment processor 120 is configured to calculate a payment to an insurance agent or employee based on the output of the compensation rate processor 118 and data stored in the database 116. In one embodiment, the payment processor calculates base compensation payments separately from supplemental commission compensation. Base compensation payments are made, for example, on a bi-monthly, monthly, or quarterly basis. The supplemental commission compensation includes payments based on the annual compensation rates and/or the partial year compensation rates. Supplemental commission payments may be made on a quarterly, bi-annual, or annual basis. Other payment schedules can be used without departing from the scope of the invention. For example, supplemental commission payments may be made on demand to enable in person delivery of supplemental commission payments coinciding with marketing or other sales meetings with the agent. In one embodiment, both the payment processor 120 and the compensation rate processor 118 are software processes executing on a common hardware processor.

The payment processor 120, in one implementation, is in communication via the communication network 106 with a bank 124. The bank 124 maintains accounts for one or more of the agents. The accounts may be savings, checking, or credit accounts. For example, in one implementation, the bank 124 maintains a credit account for each agent, whose limit is based on supplemental commission earned since an immediately preceding supplemental commission payment but which has not yet been paid. The account can be accessed by the agent through cash withdrawals or via a payment card. Any debt on the account is then paid by insurance carrier either immediately or at the time of a subsequent payment to the agent. The subsequent payment is reduced accordingly to take into account the interim payments.

The carrier terminals 122 provide various user interfaces to insurance carrier employees to interact with the compensation rate processor 118 and the payment processor 120. The interfaces include, without limitation, interfaces to add new insurance agents to the insurance carrier system 104, adjust compensation rate determination criteria for subsequent plans, and adjust payment schedules. Such interfaces may be integrated into one or more websites for managing the insurance carrier system 104 presented by the application servers 112, or they may be integrated into thin or thick software clients. The carrier terminals 122 can be any computing devices suitable for carrying out the processes described above, including personal computers, lap top computers, personal digital computers, and other computing devices with general purpose processors.

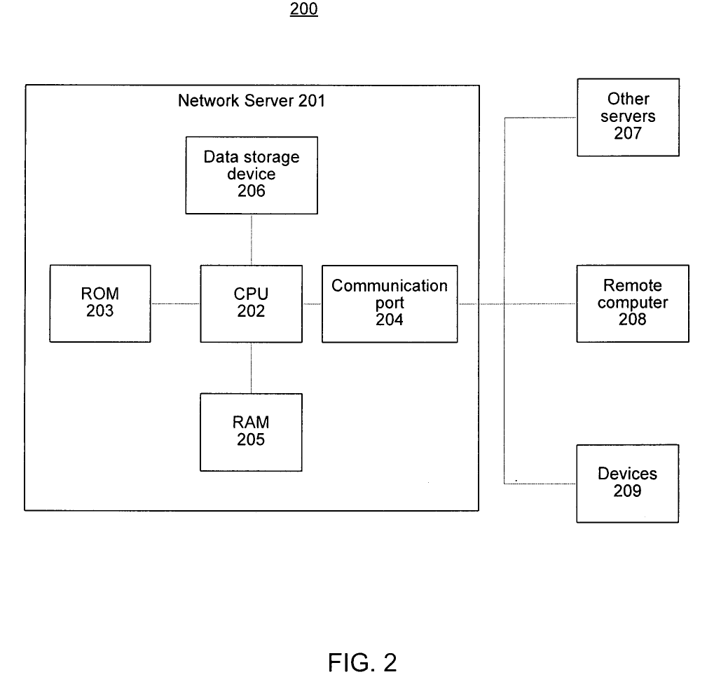

FIG. 2 is a block diagram of a computer architecture 200 suitable for implementing various servers 201 incorporated into the system 100, including, for example, the application servers 112, the compensation rate processor 118, and the payment processor 120.

Computer network server 201 comprises at least one central processing unit (CPU) 202, at least one read-only memory (ROM) 203, at least one communication port or hub 204, at least one random access memory (RAM) 205, and one or more databases or data storage devices 206. All of these later elements are in communication with the CPU 202 to facilitate the operation of the network server 201. The network server 201 may be configured in many different ways. For example, network server 201 may be a conventional standalone server computer or alternatively, the function of server may be distributed across multiple computing systems and architectures.

Network server 201 may be configured in a distributed architecture, wherein databases and processors are housed in separate units or locations. Some such servers perform primary processing functions and contain at a minimum, a general controller or a processor 202, a ROM 203, and a RAM 205. In such an embodiment, each of these servers is attached to a communications hub or port 204 that serves as a primary communication link with other servers 207, client or user computers 208 and other related devices 209. The communications hub or port 204 may have minimal processing capability itself, serving primarily as a communications router. A variety of communications protocols may be part of the system, including but not limited to: Ethernet, SAP, SAS™, ATP, BLUETOOTH™, GSM and TCP/IP.

The CPU 202 comprises a processor, such as one or more conventional microprocessors and one or more supplementary co-processors such as math co-processors. The CPU 202 is in communication with the communication port 204 through which the CPU 202 communicates with other devices such as other servers 207, user terminals 208, or devices 209. The communication port 204 may include multiple communication channels for simultaneous communication with, for example, other processors, servers or client terminals. Devices in communication with each other need not be continually transmitting to each other. On the contrary, such devices need only transmit to each other as necessary, may actually refrain from exchanging data most of the time, and may require several steps to be performed to establish a communication link between the devices.

The CPU 202 is also in communication with the data storage device 206. The data storage device 206 may comprise an appropriate combination of magnetic, optical and/or semiconductor memory, and may include, for example, RAM, ROM, flash drive, an optical disc such as a compact disc and/or a hard disk or drive. The CPU 202 and the data storage device 206 each may be, for example, located entirely within a single computer or other computing device; or connected to each other by a communication medium, such as a USB port, serial port cable, a coaxial cable, a Ethernet type cable, a telephone line, a radio frequency transceiver or other similar wireless or wired medium or combination of the foregoing. For example, the CPU 202 may be connected to the data storage device 206 via the communication port 204.

The data storage device 206 may store, for example, (i) a program (e.g., computer program code and/or a computer program product) adapted to direct the CPU 202 in accordance with the present invention, and particularly in accordance with the processes described in detail hereinafter with regard to the CPU 202; (ii) databases adapted to store information that may be utilized to store information required by the program. Suitable databases include database 116 of FIG. 1.

The program may be stored, for example, in a compressed, an uncompiled and/or an encrypted format, and may include computer program code. The instructions of the program may be read into a main memory of the processor from a computer-readable medium other than the data storage device 206, such as from a ROM 203 or from a RAM 205. While execution of sequences of instructions in the program causes the processor 202 to perform the process steps described herein, hard-wired circuitry may be used in place of, or in combination with, software instructions for implementation of the processes of the present invention. Thus, embodiments of the present invention are not limited to any specific combination of hardware and software.

Suitable computer program code may be provided for performing numerous functions such as generating a compensation rate and determining a compensation amount. The program also may include program elements such as an operating system, a database management system and “device drivers” that allow the processor to interface with computer peripheral devices (e.g., a video display, a keyboard, a computer mouse, etc.).

The term “computer-readable medium” as used herein refers to any medium that provides or participates in providing instructions to the processor of the computing device (or any other processor of a device described herein) for execution. Such a medium may take many forms, including but not limited to, non-volatile media and volatile media. Non-volatile media include, for example, optical, magnetic, or opto-magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, or any other medium from which a computer can read.

Various forms of computer readable media may be involved in carrying one or more sequences of one or more instructions to the processor 202 (or any other processor of a device described herein) for execution. For example, the instructions may initially be borne on a magnetic disk of a remote computer 208. The remote computer 208 can load the instructions into its dynamic memory and send the instructions over an Ethernet connection, cable line, or even telephone line using a modem. A communications device 204 local to a computing device (or, e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

As previously discussed with reference to FIG. 1, servers may also interact and/or control one or more user devices 209, such as displays and printers, or remote computers 208 such as, e.g., agent terminals 108 and carrier terminals 122. The terminals may include any one or a combination of a personal computer, a laptop, a personal digital assistant, a mouse, a keyboard, a computer display, a touch screen, LCD, voice recognition software, or other generally represented by input/output devices required to implement the above functionality.

FIG. 3 is a timeline 300 illustrating a method of determining an annual prospective compensation rate as might be carried out by the compensation rate processor 118 of FIG. 1, according to an illustrative embodiment of the invention. Timeline 300 includes three years, beginning on January 2007 and ending on December 2009. The selected years and number of years are merely illustrative in nature, and it should be understood that the timeline may continue in perpetuity, or until an alternative plan is put into place. Similarly, the choice of illustrating events along the timeline in relation to a calendar year is also merely for illustrative purposes. Such events may alternatively be arranged in relation to any one year period. Alternative year periods include, without limitation, the fiscal year of the insurance carrier and the years beginning with the commencement of the carrier's relation with an agent and anniversaries thereof.

The timeline illustrates three data collection periods 302a-302c (generally “data collection periods 302”), three rate calculation periods 304a-304c (generally “rate calculation periods 304”), three applied rate periods 306a-306c (generally “applied rate periods 306”), and three payment dates 308a-308c (generally “payment dates 308”). In general, the data collection periods 302 are as close to one year long as possible while retaining time to determine a subsequent year's annual prospective compensation rate and to communicate such rate to an agent prior to commencement of the next year. For example, data collection periods 302 may be approximately ten to twelve months long. The rate collection periods 304 last the remainder of the year. During this time, data for calculating annual prospective compensation rates are aggregated and processed. The resulting annual prospective compensation rates are then output to respective insurance agents, informing them of the compensation rate they will receive on new and renewal business in the following year. Such output may take the form of automatically generated form letters, automatic electronic communications, and visual output on a display. The applied rate periods 306 are one year in length. During that period, for a given insurance agent, the insurance carrier applies a corresponding annual prospective compensation rate determined based on data collected during the preceding data collection period 302 to revenue generated by the insurance agent. Insurance agents receive payments based on a given applied period's performance and the applied compensation rate determined from the data collection period 302 at a payment date 308 which falls at, or shortly after, the end of the current year.

The annual compensation rate may be based on one or more of a combination of factors including:

Policy volume: Policy volume includes the volume of insurance policies sold during the preceding data collection period 302. The volume may include the number of new policies sold, the number of policies renewed, and/or the total number of policies in force. In addition, or in the alternative, similar volume data may be stored based on a number of coverages instead of a number of policies.

Revenue: Revenue can be measured based on received premiums or based on expected annual premiums generated by policies newly sold and renewed during the preceding year.

Agent profitability: Profitability can be calculated as a net of premiums received and claims payments. In addition or in the alternative, the profitability can be measured based on a percentage of policies or coverages sold by the agent or employee that are profitable.

Policy retention: Policy retention is the percentage of policies previously sold by the agent and which were up for renewal that renewed during the preceding year.

Use of automation: Automation tools include services provided by the insurer in relation to policies sold or renewed. Such services include customer automatic electronic funds transfers, electronic billing, the use of centralized service centers, and automatic collection of premiums from the agent.

Performance improvement: Performance improvement takes into account a comparison of the preceding period's performance with an even earlier period's performance or an analysis of multiple prior periods performance. For example, performance improvement may be based on average prior performance, or prior performance trends.

Data integrity: Data integrity is a qualitative measure of the amount and quality of information the agent provides the carrier in relation to new business and claims (including, without limitation, licensing and appointment information regarding the seller of insurance). Provision of more information and more accurate information is desirable, and thus may be rewarded.

Sales campaign compliance: Insurance carriers from time to time request agents to consider and, where appropriate for the customer, promote new products and services, or undersold products and services to customers. Compliance with such initiatives may be rewarded in the annual prospective compensation rate calculation.

Product mix: Some carriers prefer specific mixes of coverages (e.g., auto versus workers compensation versus general liability) and/or customers to achieve a desired risk-return profile. Agents that extend coverages in a fashion that conforms closer to the desired mix may be rewarded, while agents that extend coverage in a non-diversified, or an undesirably diversified fashion, may not be rewarded.

Class of business: Customers in various lines of business tend to have more favorable risk profiles than others. Agents that attract more customers in such classes may therefore be rewarded.

Cross-selling of coverages: Cross-selling of coverages (e.g., life, auto, and homeowner's coverage), where appropriate, to new and existing customers may be rewarded.

The annual prospective compensation rate may include different rates for new and renewal policies, as well as different rates for different coverages. Similarly, separate rates may be calculated for payments to be made to agent principals and to licensed agent employees directly responsible for a sale or renewal. Furthermore, compensation rates may be derived based on fixed factor ranges, stored for example in a data table in database 116. Alternatively, the compensation rates may be based on a comparison to other insurance agents in an agent's peer group. Agents may be ranked based on any one or a combination of at least the factors described above. For example, rates may be determined by the decile or quartile the agent falls into.

In the timeline 300, the rate applied during the first applied rate period 306a is based on data collected in a prior year, not shown on the timeline. The rate applied during the second applied rate period 306b is based on data collected during the first data collection period 302a. The rate applied during the third applied rate period 306c is based on data collected during the second data collection period 302b. The data collected during the third data collection period 302c will be used to determine a rate for a fourth applied rate period, not shown on the timeline.

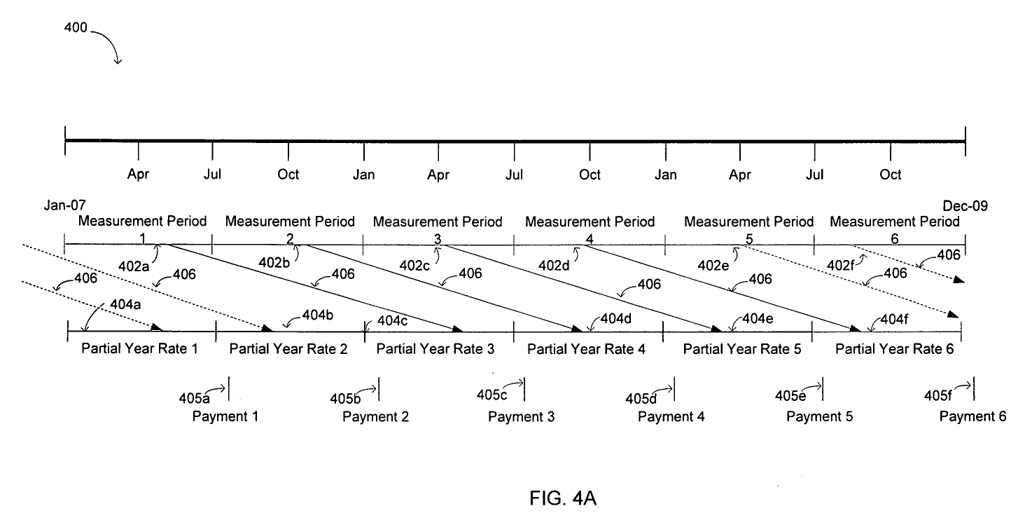

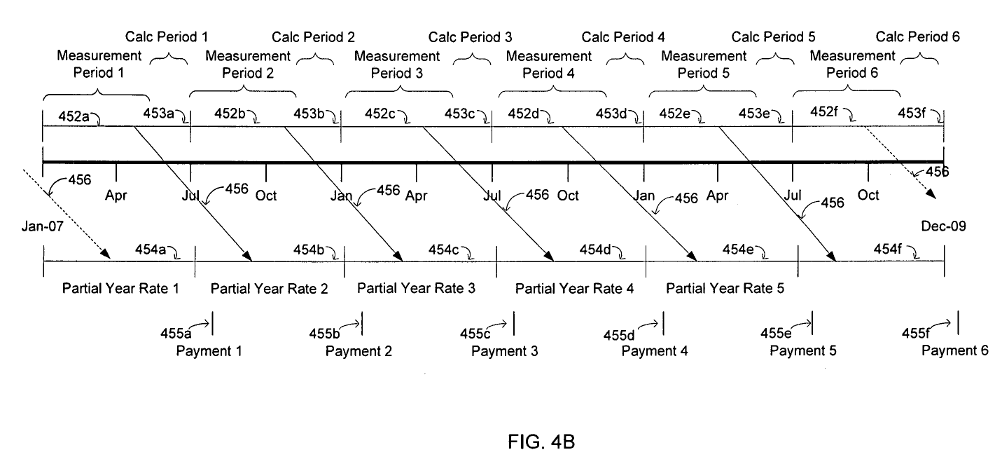

FIGS. 4A and 4B are timelines 400 and 450 of alternative prospective compensation plans that abandon the annual compensation scheme currently used in the industry. As indicated above, annual prospective compensation plans tend to perpetuate poor performance for an agent. Consider the following example typical of many annual prospective compensation plans. An agent's annual compensation rate is based on performance on a prior year. Payments resulting from annual prospective compensation plans are typically paid at the end of the year. If an agent performs poorly in year 1, even if the agent performs superbly in year 2, the agent will not see the benefits until the very end of year three. Similarly, if an agent performs poorly in the first half of year 1, any improvement during the second half of the year may not be rewarded. The compensation plans depicted in FIGS. 4A and 4B attempt to ameliorate these shortcomings. In addition, as such rates are determined prospectively, agents can provide full disclosure of their commission rates to customers who may be interested.

FIG. 4A is a timeline 400 of a compensation plan that includes multiple measurement periods 402a-402f (generally “measurement periods 402”), applied rate periods 404a-404f (generally “applied rate periods 404”), and payment dates 405a-405f (generally “payment dates 405”) in any given year. As with FIG. 3, the specific years depicted, as well as the start and end dates of each depicted period, are merely illustrative in nature.

In the compensation plan depicted in timeline 400, agents earn a partial year compensation rate instead of an annual compensation rate. Agent performance is measured over six month measurement periods 402 with corresponding six month applied rate periods 404. Thus, an agent's partial year compensation rate may change twice a year, instead of only at the end of the year. By having multiple measurement periods 402 and applied rate periods 404 during a given year, the down side of poor performance in a measurement period is limited due to a corresponding compensation rate being applied for only six months instead of a full year. In addition, insurance agents receive additional compensation more frequently. While the timeline 400 depicts only two measurement periods 402 and applied rate periods 404 per year, in alternative implementations, a compensation plan may include four or more measurement periods 402 and applied rate periods 404 per year without departing from the scope of the invention.

In the compensation plan illustrated in timeline 400, the compensation rate applied during a first applied rate period 404, will be determined based on an agent's performance during a corresponding measurement period 402 in the prior year. Correspondence between measurement periods 402 and applied rate periods 404 is depicted on the timeline 400 by arrows 406. The separation between measurement periods 402 and applied rate periods 404 takes into account seasonal variations in the insurance industry. This feature is particularly useful in compensation plans that take performance improvement into account, by insuring similar time periods are compared to one another in making a rate determination. In addition, by separating the end of a measurement period 402 with the beginning of a subsequent applied rate period 404, data from the entire measurement period 402 can be used, without having to save time for calculating new applied rates and communicating such rates to agents. The partial year compensation rate can be based on any combination of the factors described above.

FIG. 4B is a timeline 450 of a second compensation plan that includes multiple measurement periods 452a-452f (generally “measurement periods 452”), rate calculation periods 453a-453f (generally “rate calculation periods 453”), applied rate periods 454a-454f (generally “applied rate periods 454”), and payment dates 455a-455f (generally “payment dates 455”) in any given year.

In the compensation plan depicted in timeline 450, agents earn a partial year compensation rate instead of an annual compensation rate. Agent performance is measured over measurement periods 452 that take up the majority of a six month period (with the remainder of the six month period, i.e., the rate calculation period 453, being used to calculate the rate to be applied to the subsequent six month period and to inform agents of such rates) with corresponding six month applied rate periods 454. Thus, an agent's partial year compensation rate may change twice a year, instead of only at the end of the year. By having multiple measurement periods 452 and applied rate periods 454 during a given year, the down side of poor performance in a measurement period is limited due to a corresponding compensation rate being applied for only six months instead of a full year. In addition, insurance agents receive supplemental compensation more frequently. While the timeline 450 depicts only two measurement periods 452 and applied rate periods 454 per year, in alternative implementations, a compensation plan may include four or more measurement periods 452 and applied rate periods 454 per year without departing from the scope of the invention.

In the compensation plan illustrated in timeline 450, the compensation rate applied during a first applied rate period 454, will be determined based on an agent's performance during the immediately preceding measurement period 452. Correspondence between measurement periods 452 and applied rate periods 454 is depicted on the timeline 450 by arrows 456. Basing a rate for an applied rate period 454 on the immediately preceding time period increases the incentive power of the compensation plan by providing the fastest recognition by the agent of the upside of enhanced performance. The partial year compensation rate can be based on any combination of the factors described above.

In an alternative implementation, aspects of the compensation plans depicted in the timelines 300, 400, and 450 of FIGS. 3, 4A, and 4B can be combined. For example, in one implementation, applied compensation periods are six months in length. Certain factors used to calculate the partial year compensation rate for an applied rate period, e.g., revenue and profitability, are measured based on data collected from the immediate preceding measurement period. Other factors, such as performance improvement or new policy volume, are measured based on performance in the six month measurement period commencing one year prior to the applied rate period. Still other factors are derived based on data derived from performance in the entire (or substantially entire) previous year.

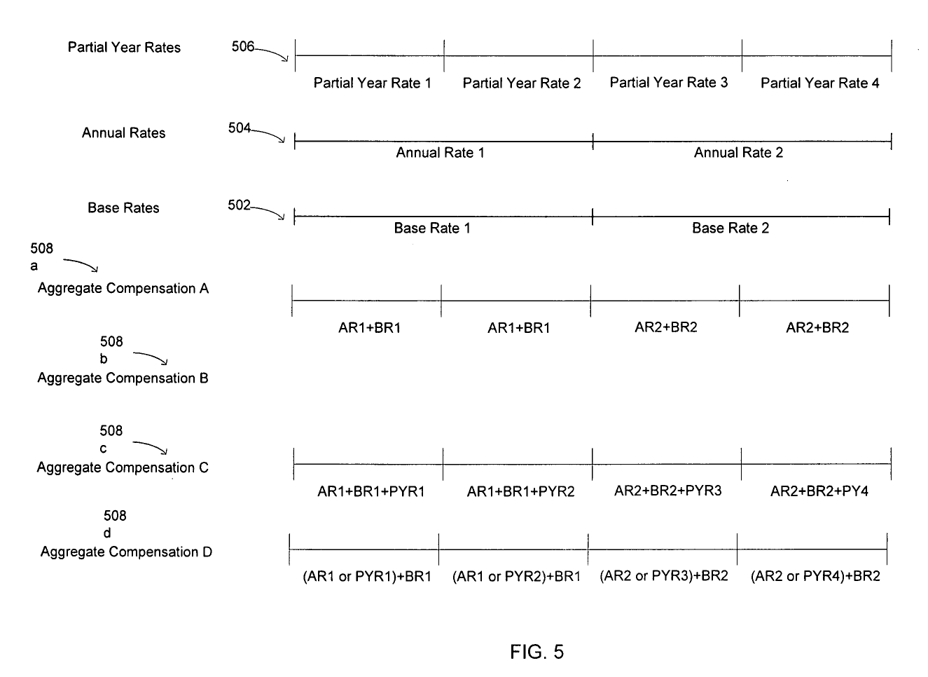

In still other embodiments, an agent's total compensation is determined based on two or more compensation components, including, for example, a base compensation rate 502, an annual prospective compensation rate 504, and a partial year compensation rate 506. More generally, a compensation component, as used herein, refers to a compensation amount or to a factor used in determining a compensation amount. FIG. 5 depicts several of these aggregated compensation plans 508a-508d. The annual prospective compensation 504 rate and the partial year compensation rates 506 are paid out to agents in the form of supplemental commissions, whereas the base compensation rate 502 is paid out as base compensation.

According to a first compensation plan 508a, an agent receives a combination of the base compensation rate 502 and an annual prospective compensation rate 504 (depicted as AR_{X}+BR_{Y}). The annual prospective compensation rate is determined as described above in relation to FIG. 3, and thus may change at the beginning of each year. The base compensation rate may change between years or during a year based on market factors. The base compensation rate, however, is agent-performance-independent.

According to a second compensation plan 508b, an agent receives a combination of the base compensation rate 502 and a partial year compensation rate 506 (depicted as BR_{Y}+PYR_{Z}). The partial year compensation rate is determined as described above in relation to FIG. 4A or 4B, and may change every six months. The base compensation rate may change between years or during a year based on market factors. The base compensation rate, however is agent-performance-independent.

According to a third compensation plan 508c, an agent receives a combination of the base compensation rate 502, the annual prospective compensation rate 504, and a partial year compensation rate 506 (depicted as AR_{X}+BR_{Y}+PYR_{Z}). The partial year compensation rate is determined as described above in relation to FIG. 4A or 4B, and may change every six months. The base compensation rate may change between years or during a year based on market factors. The base compensation rate, however is agent-performance-independent. The annual prospective compensation rate is determined as described above in relation to FIG. 3, and thus may change at the beginning of each year. The base compensation rate may change between years or during a year based on market factors. The base compensation rate, however is agent-performance-independent.

According to a fourth compensation plan 508d, in any six month period, an agent receives a combination of the base rate 502 and either the annual prospective compensation rate 504 or the partial year compensation rate 506. In one implementation, the agent receives whichever compensation rate is higher. In another implementation, the agent only receives the partial year compensation when the agent fails to qualify for the annual prospective compensation rate. In still another implementation, the agent elects which combination the agent wishes to receive at the beginning of a year. The agent, in one implementation, may change the election at his or her discretion during the year, or at predetermined times during the year. The agent can make the election, for example, using the agent terminals 108.

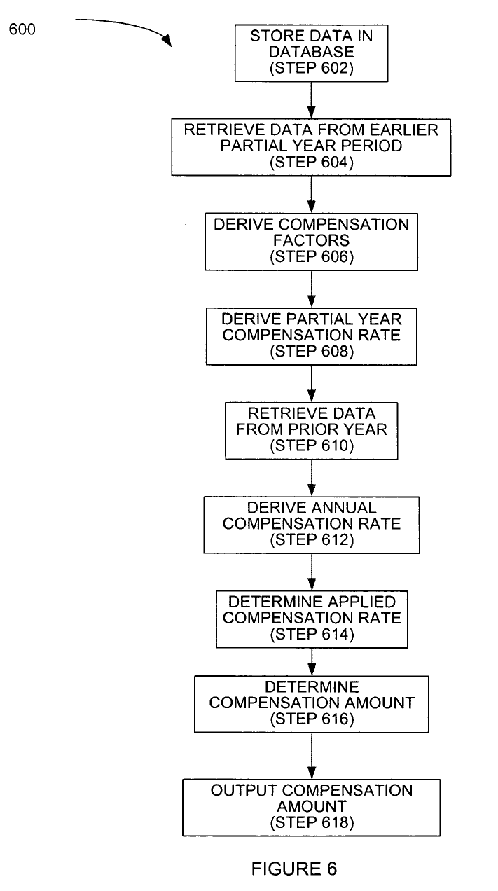

FIG. 6 is a flowchart of a method 600 of determining compensation for a seller of insurance using, for example, the system 100 of FIG. 1. Referring to FIGS. 1 and 6, the method 600 begins with the storage of data related to insurance policies in a database, such as database 116 (step 602). Data may be stored automatically in response to the issuance of a new policy, the renewal of a policy, claim activity, endorsement issuance, or other insurance related event. Alternatively, the data may be entered manually. Data is then retrieved by a processor, such as the compensation processor 118, from the database 116 in relation to a first period of time (step 604). The first period of time is substantially less than one year in length. Suitable lengths for the first period, include, for example, about three months, about four months, or about six months.

Depending on the specific compensation plan and the fields of data stored in the database 116, the processor may derive one or more compensation factors (step 606) from which to base compensation rate determinations. For example, the processor may derive a policy retention factor and/or a performance improvement factor.

Based on the retrieved data for the first period and/or the derived compensation factors, the processor derives a compensation rate to be applied to a second period (step 608). The second period is substantially less than one year in length (preferably of about equal length as the first period) and begins at or after the time the first period ends. For example, the second period may begin six months after the end of the first period.

In one embodiment, the processor retrieves data from the database related to the performance of the seller of insurance during the immediately preceding year (step 610). The processor then derives an annual prospective compensation rate based on this retrieved data (step 612). Based on the partial year compensation rate derived in step 608 and the annual prospective compensation rate derived in step 612, the processor determines an applied compensation rate (step 614). In one implementation, the annual prospective compensation rate and the partial year compensation rate derived in step 608 are combined (e.g., added to one another) to form an applied compensation rate. Alternative combinations may also be appropriate. For example, in one implementation, the partial year compensation rate is a factor which is multiplied with the annual prospective compensation rate to determine the applied compensation rate. In an alternative embodiment, the processor determines the applied compensation rate (step 614) by substituting the partial year compensation rate derived in step 608 for the annual prospective compensation rate determined in step 612.

The processor then applies the applied compensation rate to revenue attributed to the seller of insurance to determine a compensation amount for the seller (step 616). In one implementation, the processor derives single compensation rates and compensation amounts to be applied and paid, respectively, to an agency as a whole or it may also derive a compensation rate to be applied to a specific licensed agency employee. Compensation paid to an agency as a whole is made to principals of the agency.

The processor then outputs the determined compensation amount (step 618). For example, the processor may output the compensation amount via a printer, display, and/or electronic communication to the finance department of the insurance carrier and/or to a seller of insurance. In one implementation, the processor executes steps 616 and 618 at the end of each second period. In an alternative implementation, steps 616 and 618 are carried out on a regular basis (e.g., weekly, monthly, or quarterly) and/or on demand. In such implementation, the compensation amount may also be output to a bank as described in FIG. 1 to enable a seller of insurance to obtain interim payments on earned compensation.

The following are non-limiting examples of specific compensation plans suitable for implementing using the systems and methods described above.

### EXAMPLE 1

In the first example, agents are eligible for biannual supplemental commission payments. The supplemental commission payments for a given applied rate period are based on the premiums associated with newly issued policies during the applied rate period. More specifically, the supplemental commission is equal to the product of the premiums associated with the new policies and a partial year compensation rate that varies between 0% and 5%.

The partial year compensation rate for the applied rate period is determined before the beginning of the applied rate period based on the total premiums (including new and renewal policy premiums) written during a corresponding six month period in the preceding calendar year and a premium ratio comparing the total premiums written during the corresponding period in the prior year and the total premiums written during a corresponding period in the year before that. For example, for a period including July through December of 2008, the partial year compensation rate will be based on the total premiums written during July through December of 2007 and a ratio of the total premiums written during July through December of 2007 to the total premiums written during July through December of 2006. In addition, eligibility for the partial year supplemental commission is limited to agents With loss ratios (i.e., the ratio of losses to premiums) during the July through December of 2007 period of less than 55%. Tables 1-5 below illustrate partial year compensation rates associated with various performance levels.

TABLE 1
Total Written Premium less than $250,000

| Premium Ratio Range | Premium Ratio Factor |
|---|---|
| 100% to 109.9% | 0% |
| 110% to 119.9% | 1% |
| 120% to 129.9% | 2% |
| Over 130% | 3% |

TABLE 2
Total Written Premium from $250,000 to $499,999

| Premium Ratio Range | Premium Ratio Factor |
|---|---|
| 100% to 104.9% | 0% |
| 105% to 109.9% | 1% |
| 110% to 119.9% | 2% |
| 120% to 129.9% | 3% |
| Over 130% | 4% |

TABLE 3
Total Written Premium from $500,000 to $749,999

| Premium Ratio Range | Premium Ratio Factor |
|---|---|
| 100% to 103.9% | 0% |
| 104% to 109.9% | 2% |
| 110% to 119.9% | 3% |
| Over 120% | 4% |

TABLE 4
Total Written Premium from $750,000 to $1,499,999

| Premium Ratio Range | Premium Ratio Factor |
|---|---|
| 100% to 102.9% | 0% |
| 103% to 109.9% | 3% |
| Over 110% | 4% |

TABLE 5
Total Written Premium greater than or equal to $1,500,000

| Premium Ratio Range | Premium Ratio Factor |
|---|---|
| 100% to 102.9% | 0% |
| 103% to 109.9% | 4% |
| Over 110% | 5% |

### EXAMPLE 2

In a second example, partial year compensation is tied to a particular line of insurance coverage, specifically personal lines automobile coverage. Agents eligible for this compensation plan are also eligible for an annual prospective compensation supplemental commissions. However, during any given year, an agent can only earn supplemental commissions based on the annual rate or the partial year rate. Agents who fail to qualify for the annual prospective supplemental commission based on insufficient performance in the prior year automatically qualify for the partial year supplemental commission, unless otherwise disqualified as discussed below. In addition, prior to the beginning of a year, agents may proactively forgo the annual prospective supplemental commission in favor of the partial year supplemental commission. Agents may be disqualified from participating in the partial year compensation based on having insufficient Policy Inforce Ratios (i.e., the ratio of number of policies in force in the immediately preceding six month period to the number of policies in force during the six month period prior to that) or poor profitability (i.e., a loss ratio comparing the losses and premiums of the immediately preceding six month period of greater than 55%).

The partial year supplemental commission is calculated using two compensation rates, one for new written premiums, and one for renewal premiums. Each compensation rate is based purely on the number of new standard auto policies written in the prior six month period. Table 6 illustrates an example table for determining partial year supplemental commission rates.

TABLE 6

| | Standard Auto New Policy Count | | | | | |
|---|---|---|---|---|---|---|
| | 0-29 | 30-59 | 60-124 | 125-249 | 250-499 | 500 or more |
| New Written Premium Factor | 0.00% | 1.00% | 2.00% | 3.00% | 4.00% | 5.00% |
| Renewal Written Premium Factor | 0.00% | 0.00% | 1.00% | 2.00% | 3.00% | 4.00% |

The invention may be embodied in other specific forms without departing from the spirit or essential characteristics thereof. The forgoing embodiments are therefore to be considered in all respects illustrative, rather than limiting of the invention.

What is claimed is:

1. A system for determining a compensation component for a seller of insurance comprising:
a database for storing insurance policy data attributed with the seller of insurance;
a processor configured for
retrieving, from the database, insurance policy data for a first period of time, wherein the first period of time is substantially less than one year in length;
deriving, based on the retrieved insurance policy data, a partial year compensation rate for the seller of insurance to apply to a second period of time, wherein the second period is substantially less than one year in length and the first period of time ends prior to beginning of the second period of time; and
outputting the derived partial year compensation rate.

2. The system of claim 1, wherein the processor is configured to output the derived partial year compensation rate prior to commencement of the second period.

3. The system of claim 1, comprising a payment system for initiating payment of compensation to a seller of insurance based on the derived partial year compensation rate.

4. The system of a claim 3, wherein the payment initiated by the payment system is based on an addition of a base commission and a supplemental commission, wherein the supplemental compensation is further based on the derived partial year compensation rate.

5. The system of claim 1, wherein the database stores data indicative of a level of cross-selling carried out by the seller of insurance during the first period of time, and the processor is configured for deriving the partial year compensation rate based at least in part on the level of cross-selling during the first period of time.

6. The system of claim 1, wherein the database stores data indicative of the profitability of insurance policies sold by the seller of insurance, and the processor is configured for deriving the partial year compensation rate based at least in part on the profitability of the insurance policies sold during the first period of time.

7. The system of claim 1, wherein the database stores data indicative of volume of insurance policies sold by the seller of insurance, and the processor is configured for deriving the partial year compensation rate based at least in part on the volume of insurance policies sold during the first period of time.

8. The system of claim 7, wherein the volume of insurance policies sold includes the volume of new insurance policies sold by the seller of insurance.

9. The system of claim 7, wherein the volume of insurance policies sold includes the volume of new insurance policies sold and the volume of insurance policies renewed by the seller of insurance.

10. The system of claim 1, wherein the processor is configured for deriving a policy retention factor for the first period based on the retrieved data, and the processor is configured for deriving the partial year compensation rate based at least in part on the retention factor.

11. The system of claim 1, wherein the processor is configured to calculate a performance improvement factor indicative of a the difference between the performance of the seller of insurance during the first period and the performance of the seller during a third period, prior to the first period, and the processor derives the partial year compensation rate based at least in part on the improvement factor.

12. The system of claim 1, wherein the database stores data indicative of revenue attributed to the seller of insurance during the first period, and the processor is configured for deriving the partial year compensation rate based at least in part on the attributed revenue.

13. The system of claim 1, wherein the database stores data indicative of a level or quality of information provided by the seller of insurance and the processor is configured for deriving the partial year compensation rate based at least in part on the information provision level or quality.

14. The system of claim 1, wherein the processor is configured to:
retrieve data from the database reflecting performance of the seller of insurance during substantially the entirety of an immediately preceding calendar year and calculate an annual prospective compensation rate based thereon, and
derive an aggregate partial year compensation rate based on the annual prospective compensation rate and the partial year compensation rate.

15. The system of claim 1, wherein the processor is further configured for:
applying the derived partial year compensation rate to revenue attributed to the seller of insurance during the second period to determine a compensation amount for the seller of insurance; and
outputting the determined compensation amount.

16. The system of claim 15, wherein the processor is configured for scheduling payment of the payment amount to the seller of insurance.

17. The system of claim 16, wherein the processor is configured for allocating funds to an account associated with the seller of insurance prior to a scheduled payment based on the determined compensation amount, thereby enabling the seller of insurance to obtain an interim payment on the determined compensation amount.

18. The system of claim 1, wherein the seller of insurance comprises an insurance agency.

19. The system of claim 1, wherein the seller of insurance comprises an employee of an insurance agency.

20. The system of claim 1, wherein deriving the partial year compensation rate comprises determining a first rate to be paid to an employee of the seller of insurance and a second rate to paid to a principal of the seller of insurance.

21. The system of claim 1, wherein the first period consists of a period approximately six months in length.

22. The system of claim 1, wherein the first period consists of a period approximately three months in length.

23. The system of claim 1, wherein the processor is configured to substitute the derived partial year compensation rate for an annual prospective compensation rate.

24. A method for determining a compensation component for a seller of insurance comprising:
storing insurance policy data attributed with the seller of insurance in a database;
retrieving, by a processor, from the database, insurance policy data for a first period of time, wherein the first period of time is substantially less than one year in length;
deriving, by the processor, based on the retrieved insurance policy data, a partial year compensation rate for the seller of insurance to apply to a second period of time, wherein the second period is substantially less than one year in length and the first period of time ends prior to beginning of the second period of time; and
outputting, by the processor, the derived partial year compensation rate.

25. The method of claim 24, wherein outputting the derived partial year compensation rate comprises outputting the derived partial year compensation rate prior to commencement of the second period.

26. The method of claim 24, wherein the database stores data indicative of a level of cross-selling carried out by the seller of insurance during the first period of time, and the partial year compensation rate is derived by the processor based at least in part on the level of cross-selling during the first period of time.

27. The method of claim 24, wherein the database stores data indicative of the profitability of insurance policies sold by the seller of insurance, and the partial year compensation rate is derived by the processor based at least in part on the profitability of the insurance policies sold during the first time period.

28. The method of claim 24, wherein the database stores data indicative of volume of insurance policies sold by the seller of insurance, and the partial year compensation rate is derived by the processor based at least in part on the volume of insurance policies sold during the first time period.

29. The method of claim 24, wherein the processor is configured for deriving a policy retention factor for the first period based on the retrieved data, and the partial year compensation rate is derived by the processor based at least in part on the retention factor.

30. The method of claim 24, wherein the processor is configured to calculate a performance improvement factor indicative of a the difference between the performance of the seller of insurance during the first period and the performance of the seller during a third period, prior to the first period, and the partial year compensation rate is derived by the processor based at least in part on the improvement factor.

31. The method of claim 24, wherein the database stores data indicative of revenue attributed to the seller of insurance during the first period, and the partial year compensation rate is derived by the processor based at least in part on the attributed revenue.

32. The method of claim 24, wherein the database stores data indicative of a level or quality of information provided by the seller of insurance and the partial year compensation rate is derived by the processor based at least in part on the information provision level or quality.

33. The method of claim 24, comprising:
retrieving, by the processor, data from the database reflecting performance of the seller of insurance during substantially the entirety of an immediately preceding calendar year and calculating an annual prospective compensation rate based thereon, and
deriving, by the processor, an aggregate partial year compensation rate based on the annual prospective compensation rate and the partial year compensation rate.

34. The method of claim 24, comprising:
applying, by the processor, the derived partial year compensation rate to revenue attributed to the seller of insurance during the second period to determine a compensation amount for the seller of insurance; and
outputting, by the processor, the determined compensation amount.

35. The method of claim 34, wherein determining the compensation amount further comprises adding the compensation amount determined based on the partial year compensation rate to a compensation amount based on a base commission rate.

36. The method of claim 34, comprising scheduling, by the processor, payment of the payment amount to the seller of insurance.

37. The method of claim 36, comprising allocating funds, by the processor, to an account associated with the seller of insurance prior to a scheduled payment based on the determined compensation amount, thereby enabling the seller of insurance to obtain an interim payment based on the determined compensation amount.

38. The method of claim 24, wherein deriving the partial year compensation rate comprises determining a first rate to be paid to an employee of the seller of insurance and a second rate to paid to a principle of the seller of insurance.

39. The method of claim 24, wherein the processor is configured to substitute the derived partial year compensation rate for an annual prospective compensation rate.

40. A computer readable medium storing computer executable instructions, which when executed by a processor, cause the processor to carry out a method for determining a compensation component for a seller of insurance, the method comprising:
storing insurance policy data attributed with the seller of insurance in a database;
retrieving, by the processor, from the database, insurance policy data for a first period of time, wherein the first period of time is substantially less than one year in length;
deriving, by the processor, based on the retrieved insurance policy data, a partial year compensation rate for the seller of insurance to apply to a second period of time, wherein the second period is substantially less than one year in length and the first period of time ends prior to beginning of the second period of time; and
outputting, by the processor, the derived partial year compensation rate.

41. The computer readable medium of claim 40, wherein the computer executable instructions cause the processor to:
applying, by the processor, the derived partial year compensation rate to revenue attributed to the seller of insurance during the second period to determine a compensation amount for the seller of insurance; and
outputting, by the processor, the determined compensation amount.

42. The computer readable medium of claim 41, wherein the computer executable instructions cause the processor to determine the compensation amount by adding the compensation amount determined based on the partial year compensation rate to a compensation amount based on a base commission rate.
